(19) United States
(12) Patent Application Publication
(10) Pub. No.: US 2005/0087290 A1
(43) Pub. Date: Apr. 28, 2005

(54) Method for joining transparent plastic substrates

(76) Inventors: Julius Herold, Plankstadt (DE); Robert Magunia, Elztal-Dallau (DE); Manfred Rein, Bad Schoenborn (DE); Silvia Gruenewald, Milton Keynes (GB); Rolf Wirth, Bruckmuehl-Heufeld (DE); Thorsten Huelsmann, Schechen (DE); Kai Baer, Bruckmuehl-Huefeld (DE)

Correspondence Address: HENKEL CORPORATION, THE TRIAD, SUITE 200, 2200 RENAISSANCE BLVD., GULPH MILLS, PA, 19406, US

(21) Appl. No.: 10/931,912

(22) Filed: Sep. 1, 2004

Related U.S. Application Data
(63) Continuation of application No. PCT/EP03/02019, filed on Feb. 27, 2003.

(30) Foreign Application Priority Data
Mar. 8, 2002 (DE) 102 10 082.9

(51) Int. Cl. B32B 31/00

(52) U.S. Cl. 156/272.2; 156/292

(57) ABSTRACT

A method is provided for bonding shaped parts using a heat-curable adhesive by joining the parts with the adhesive and exposing the adhesive in the bonded joint thereby formed to electromagnetic radiation, at least part of the radiation being in the near infra-red. At least one of the parts is transparent to the electromagnetic radiation in the area of the bonded joint. This method is particularly suitable for producing vehicle lamp or headlight assemblies.

### CROSS-REFERENCE TO RELATED APPLICATIONS

This application is a continuation under 35 USC Sections 365(c) and 120 of International Application No. PCT/EP03/02019, filed 27 Feb. 2003 and published 18 Sep. 2003 as WO 03/076167, which claims priority from German Application No. 10210082.9, filed 8 Mar. 2002, each of which is incorporated herein by reference in its entirety.

### FIELD OF THE INVENTION

This invention relates to a process for joining transparent plastic substrates to thermoplastic or thermosetting plastic substrates and to its use for the production of lamp housings for motor vehicle lights or headlamps.

### DISCUSSION OF THE RELATED ART

It is known that lamp housings for motor vehicle lights or headlamps can be producing by joining processes in which a first component, for example a headlamp housing, comprises a U-shaped sealing bed on a first side wall into which a second component, for example a glass lens or cover, with a second side wall can be fitted, so that both components are joined sealingly to one another. The glass lenses or even glass diffusors are now often replaced by lenses of transparent plastic substrates, preferably polymethyl methacrylate (PMMA) or polycarbonate (PC).

DE 1604736 A describes a process for joining plastic parts in which the side wall of a first component comprises a U-shaped sealing bed into which the side wall of a second component is fitted, a liquid adhesive/sealing compound being introduced into the sealing bed through lateral openings after the components have been fitted together. Curable, non-elastic materials such as, for example, hot- or cold-curing polyester mixtures, epoxy resin combinations or thermoplastics are proposed for the establishment of irreversible bonds. Rubber mixtures, for example, silicone rubber, are proposed for the establishment of dissolvable bonds. Joining processes such as these are time-consuming and involve much manual work.

WO 96/24643 proposes hotmelt adhesives for joining glass-like materials to thermoplastic or thermosetting plastic materials. More particularly, these hotmelt adhesives are said to be used for joining lenses to lamp housings of motor vehicle lights or headlamps. The hotmelt adhesives actually proposed include hotmelts containing grafted thermoplastic elastomers, optionally grafted poly-α-olefins, adhesive resins and polyisobutylenes. More particularly, reactive hotmelts which acquire their ultimate strength through a subsequent crosslinking reaction are proposed.

EP 1108771 A2 describes a process for joining a first component to a second component, in which a removable adhesive/sealing compound is applied in the solid state to a sealing bed region of the first component and the two components are fitted together. For removal, the adhesive/sealing compound is gripped at a free end and withdrawn almost completely from the sealing bed in an even extension thereof directed away from the two components.

### DESCRIPTION OF THE FIGURES

FIG. 1 shows part of a lamp housing being assembled in accordance with the process of the present invention.

FIG. 2 shows the groove part of the joint in a lamp housing.

FIG. 3 shows the tongue part of the joint in a lamp housing.

### BRIEF SUMMARY OF THE INVENTION

In view of this prior art, the problem addressed by the present invention was to provide a process for joining moldings, more particularly lamp housings, which would provide for rapid joining and production and would lead to durable bonds between the components.

The solution to this problem as provided by the invention is defined in the claims and is essentially characterized in that at least one component is transparent to electromagnetic radiation in the vicinity of the bonded joint. This component is preferably made of glass or a transparent plastic. Examples of transparent plastics are, in particular, PLEXIGLASS (polymethyl methacrylate, PMMA), polycarbonate (PC) or polystyrene and styrene copolymers. In a preferred embodiment, at least significant parts of the radiation by which the adhesive is heated are in the wavelength range of the near infrared.

### DETAILED DESCRIPTION OF CERTAIN EMBODIMENTS OF THE INVENTION

In the context of the invention, “near infrared radiation (near IR radiation)” is understood to be an electromagnetic radiation which immediately adjoins the visible light on the long-wave side and which is preferably in a wavelength range of 0.7 μm to 1.5 μm. “Near IR” is used in the scientific literature as an abbreviation for “near infrared”. It is known that, in this wavelength range, infrared radiation has the highest energy density and very favorable effects. More particularly, it has been found that, in contrast to longer-wave IR radiation, near IR radiation is able to penetrate more deeply into the adhesive to be heated and does not only heat the surface of the adhesive layer. In addition, with suitable devices, near IR radiation can be focussed very effectively with little effort, providing a directed, high-energy near IR radiation which provides for very short heating times of the adhesive layer to be activated of the order of a few seconds without overly heating a heat-sensitive substrate. The near IR radiation source preferably has a thermal emitter which can be operated at emission temperatures of 2,500 K or higher, preferably 2,900 K or higher. Preferred radiation sources such as these are halogen lamps. Typically, the near IR radiation source unit is designed so that, during the curing phase, it either sweeps over the entire bonded joint once or “travels down” the bonded joint on a predetermined path. In both cases, a control unit controls the energy input and hence the temperature of the adhesive layer to be heated via sensors.

The heat-curing adhesive curable by near IR radiation may be based on a non-aqueous dispersion containing at least one polyisocyanate solid at room temperature, which is only deactivated at the surface, and at least one isocyanate-reactive polymer. Besides its joining function imparting structural strength to the bond, the heat-curing adhesive also has a sealing effect on the components in the process according to the invention.

The binder of the heat-curing adhesives/sealants contains polyols such as, for example, polyether polyols, polyester polyols, polyacrylate polyols, polyolefin polyols and/or polyether ester polyols, polyether amines and a fine-particle di- or polyisocyanate which is deactivated at its surface during dispersion in the polyol/polyamine mixture.

In addition to the constituents mentioned above, the adhesive/sealant generally contains fillers, optionally powder-form molecular sieve or other water-binding constituents and catalysts.

Several relatively high molecular weight polyhydroxy compounds may be used as the polyols. Suitable polyols are, preferably, the polyethers liquid at room temperature which contain two or three hydroxyl groups per molecule and which have molecular weights in the range from 400 to 20,000 and preferably in the range from 1,000 to 15,000. Examples are difunctional and/or trifunctional polypropylene glycols although statistical and/or block copolymers of ethylene oxide or propylene oxide may also be used. Another group of preferred polyethers are the polytetramethylene glycols (poly(oxytetramethylene)glycol, poly-THF) obtained, for example, by the acidic polymerization of tetrahydrofuran. The molecular weight of the polytetramethylene glycols is in the range from 200 to 6,000 and preferably in the range from 800 to 5,000.

Other suitable polyols are the liquid, glass-like and amorphous or crystalline polyesters obtainable by condensation of di- or tricarboxylic acids such as, for example, adipic acid, sebacic acid, glutaric acid, azelaic acid, suberic acid, undecanedioic acid, dodecanedioic acid, 3,3-dimethylglutaric acid, terephthalic acid, isophthalic acid, hexahydrophthalic acid, dimer fatty acid or mixtures thereof with low molecular weight diols or triols such as, for example, ethylene glycol, propylene glycol, diethylene glycol, triethylene glycol, dipropylene glycol, butane-1,4-diol, hexane-1,6-diol, octane-1,8-diol, decane-1,10-diol, dodecane-1,12-diol, dimer fatty alcohol, glycerol, trimethylol propane or mixtures thereof. Another group of polyols suitable for use in accordance with the invention are the polyesters based on ε-caprolactone also known as “polycaprolactones”. However, polyester polyols of oleochemical origin may also be used. Oleochemical polyester polyols may be obtained, for example, by complete ring opening of epoxidized triglycerides of a fatty mixture containing at least partly olefinically unsaturated fatty acids with one or more alcohols containing 1 to 12 carbon atoms and subsequent partial transesterification of the triglyceride derivatives to form alkyl ester polyols with 1 to 12 carbon atoms in the alkyl group. Other suitable polyols are polycarbonate polyols and dimer diols (Henkel) and also castor oil and derivatives thereof. The hydroxyfunctional polybutadienes known, for example, by the commercial name of “POLY-BD” may also be used as polyols for the compositions according to the invention.

Other suitable polyols are linear and/or lightly branched acrylate copolymer polyols which may be produced, for example, by the radical copolymerization of acrylates or methacrylates with hydroxyfunctional acrylic acid and/or methacrylic acid compounds, such as hydroxyethyl (meth)acrylate or hydroxypropyl (meth)acrylate. In view of this method of production, the hydroxyl groups in these polyols are generally statistically distributed, so that the polyols are either linear or lightly branched polyols with an average OH functionality.

Preferred di- or trifunctional amino-terminated polymers are amino-terminated polyalkylene glycols, more particularly difunctional amino-terminated polypropylene glycols, polyethylene glycols or copolymers of propylene glycol and ethylene glycol. These glycols are also known under the commercial name of “JEFFAMINE” (Huntsman). The difunctional amino-terminated polyoxytetramethylene glycols, also known as Poly-THF, are also suitable. Other suitable synthesis components are difunctional amino-terminated polybutadiene compounds and aminobenzoic acid esters of polypropylene glycols, polyethylene glycols or Poly-THF (known commercially as “VERSALINK oligomeric diamines” of Air Products). The amino-terminated polyalkylene glycols or polybutadienes have molecular weights of 400 to 6,000.

Suitable solid surface-deactivated polyisocyanates are any solid di- or polyisocyanates or mixtures thereof providing they have a melting point above +40° C. They may be aliphatic, cycloaliphatic, heterocyclic or aromatic polyisocyanates. Examples include diphenylmethane-4,4′-diisocyanate (4,4′-MDI), dimeric 4,4′-MDI, naphthalene-1,5-diisocyanate (NDI), 3,3′-dimethylbiphenyl-4,4′-diisocyanate (TODI), dimeric 1-methyl-2,4-phenylene diisocyanate (TDI-U), 3,3′-diisocyanato-4,4′-dimethyl-N,N′-diphenylurea (TDIH), addition product of 2 mol 4,4′-MDI with 1 mol diethylene glycol, addition products of 2 mol 1-methyl-2,4-phenylene diisocyanate with 1 mol ethane-1,2-diol or butane-1,4-diol, the isocyanurate of IPDI (IPDI-T).

The solid polyisocyanates should preferably be powders with a mean particle diameter of or below 10 μm (weight average). They generally accumulate as powders with the required particle sizes of or below 10 μm during the synthesis process; otherwise the solid polyisocyanates have to be brought into the particle size range according to the invention (before deactivation) by grinding and/or sieving. The relevant processes are known.

Alternatively, the powder-form polyisocyanates can be brought to a mean particle size of or below 10 μm by wet grinding and fine dispersion after surface deactivation. Dispersion units of the rotor/stator type, stirred ball mills, bead and sand mills, ball mills and friction gap mills are suitable for this purpose. Depending on the polyisocyanate and the intended application, the deactivated polyisocyanate is ground in the presence of the deactivating agent or in the non-reactive dispersant with subsequent deactivation. The ground and surface-stabilized polyisocyanate may also be removed from the grinding dispersions and optionally dried. The process is described in EP 204970.

The surface stabilizing reaction may be carried out in various ways:
by dispersing the powder-form isocyanate in a solution of the deactivating agent;
by introducing a melt of a low-melting polyisocyanate into a solution of the deactivating agent in a non-dissolving liquid dispersant;
by adding the deactivating agent or a solution thereof to the dispersion of the solid fine-particle isocyanates.

The solid polyisocyanates are preferably deactivated by the action of primary and secondary aliphatic mono-, di- or polyamines, hydrazine derivatives, amidines, guanidines. Deactivators which have been successfully used include ethylene diamine, 1,3-propylene diamine, diethylene triamine, triethylene tetramine, 2,5-dimethyl piperazine, 3,3′-dimethyl-4,4′-diaminodicyclohexyl methane, methylnonane diamine, isophorone diamine, 4,4′-diaminodicyclohexyl methane, diamino- and triaminopolypropylene ether, polyamidoamines and mixtures of mono-, di- and polyamines. The above-mentioned amino-terminated polypropylene glycols, polyethylene glycols or copolymers of propylene glycol and ethylene glycol are most particularly preferred.

The concentration of the deactivator should be between 0.1 and 20 and preferably between 0.5 and 8 equivalent percent, based on the total of isocyanate groups present.

Preferred fillers are chalks, natural ground or precipitated calcium carbonates, calcium magnesium carbonates (dolomite), silicates such as, for example, aluminium silicates, heavy spar or magnesium aluminium silicates or even talcum. In addition, other fillers, more particularly reinforcing fillers, such as carbon blacks selected from the group of flame blacks, channel blacks, gas blacks or furnace blacks or mixtures thereof, may optionally be used. The adhesives/sealants according to the invention may additionally contain plasticizers or plasticizer mixtures and catalysts, stabilizers and other auxiliaries and additives.

Suitable catalysts are tertiary amines, more particularly aliphatic amines with a cyclic structure. Among the tertiary amines, those which additionally contain isocyanate-reactive groups, more particularly hydroxyl and/or amino groups, are also suitable. Specific examples of such tertiary amines are dimethyl monoethanolamine, diethyl monoethanolamine, methyl ethyl monoethanolamine, triethanolamine, trimethanolamine, tripropanolamine, tributanolamine, trihexanolamine, tripentanolamine, tricyclohexanolamine, diethanol methyl amine, diethanol ethyl amine, diethanol propyl amine, diethanol butyl amine, diethanol pentyl amine, diethanol hexyl amine, diethanol cyclohexyl amine, diethanol phenyl amine and ethoxylation and propoxylation products thereof, diazabicyclooctane (DABCO), triethyl amine, dimethyl benzyl amine (DESMORAPID DB, BAYER AG), bis-dimethylaminoethyl ether (Catalyst A 1, UCC), tetramethyl guanidine, bis-dimethylaminomethylphenol, 2-(2-dimethylaminoethoxy)-ethanol, 2-dimethylaminoethyl-3-dimethylaminopropyl ether, bis-(2-dimethylaminoethyl)-ether, N,N-dimethyl piperazine, N-(2-hydroxyethoxy-ethyl)-2-azanorbornane, or even unsaturated bicyclic amines, for example diazabicycloundecane (DBU) and TEXACAT DP-914 (Texaco Chemical), N,N,N,N-tetramethylbutane-1,3-diamine, N,N,N,N-tetramethylpropane-1,3-diamine and N,N,N,N-tetramethylhexane-1,6-diamine.

Adhesives/sealants of low specific gravity can be produced using other, light fillers, for example plastic microspheres, preferably in pre-expanded form. These microspheres may either be directly added to the adhesive/sealant in pre-expanded form as microspheres or the microspheres are added to the adhesive/sealant in unfoamed form as a fine-particle powder. These unfoamed microspheres expand on heating of the adhesive/sealant and thus provide for very uniform and fine-cell foaming. The microspheres contain a liquid blowing agent based on aliphatic hydrocarbons or fluorocarbons as core and a shell of a copolymer of acrylonitrile with vinylidene chloride and/or methyl methacrylate and/or methacrylonitrile. Where microspheres such as these are used, the expansion of the microspheres and hence foaming only take place during the curing of the adhesive/sealant. The use of such microspheres is described, for example, in EP-A-559254. They are commercially obtainable, for example, under the names of EXPANCEL (Nobel Industries) and DUALITE (Pierce & Stevens).

In addition, additives may be introduced to control flow behavior. Such additives include, for example, urea derivatives, fibrillated fibers or chopped pulping fibers, pyrogenic silicas and the like.

Although the adhesives/sealants to be used in accordance with the invention preferably contain no plasticizers, it may occasionally be necessary to use plasticizers known per se. Dialkyl phthalates, dialkyl adipates, dialkyl sebacates, alkyl aryl phthalates, alkyl benzoates, dibenzoates or polyols, such as ethylene glycol, propylene glycol, or the lower polyoxypropylene or polyoxyethylene compounds may be used for this purpose. Other suitable plasticizers are alkyl phosphates, aryl phosphates or alkylaryl phosphates and alkyl sulfonic acid esters of phenol or even paraffinic or naphthenic oils or dearomaticized hydrocarbons as diluents. Where plasticizers are used, it is important that they are selected so that they do not attack the surface deactivation layer of the deactivated fine-particle polyisocyanates during storage of the adhesive/sealant because this would result in premature curing of the adhesive/sealant strand.

To carry out the process according to the invention, the bonded joint between the parts to be joined should be so designed that at least part is transparent to electromagnetic radiation. Accordingly, the region where the parts are joined is preferably so designed that the electromagnetic radiation is able to reach the bonded joint through the glass part or the transparent plastic part of the combination of parts.

One embodiment of the invention is described in detail in the following with reference to the accompanying drawings, wherein:

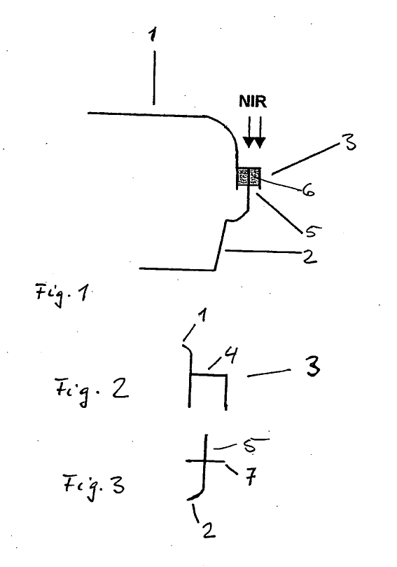

FIG. 1 shows part of a lamp housing.

FIG. 2 shows the groove part of the joint.

FIG. 3 shows the tongue part of the joint.

FIG. 1 shows parts of a lamp housing, the part (1) representing part of a lens or diffusor of the lamp housing of glass or transparent plastic which has a U-shaped groove (3) at its edge. The lower part of the lamp housing (2) has a tongue-like projection (5) which, after fitting together, engages in the U-shaped part of the groove. The space surrounded by the tongue and groove is completely filled with the heat-curing adhesive (6).

FIG. 2 shows part of the groove (3) in detail. It is important in this connection that the horizontal section (4) of the groove consists of the glass or transparent plastic of the lamp housing part (1) and is permeable to the electromagnetic radiation of the near IR, so that the near IR is able to penetrate deeply into the adhesive so that curing takes place very quickly.

FIG. 3 shows the tongue 5 in detail. The tongue preferably has projections (7) which are perpendicular to the tongue (5) and which form the lower closure of the bonded joint.

The invention is further illustrated by the following Examples which do not cover the full scope of the bonding process according to the invention. However, the full range of application of the process according to the invention is clear to the expert from the foregoing.

### EXAMPLES

### Example 1

### Production of a Heat-curing Adhesive

22 g of a mixed polyether/polyester polyol (OH value 160), 200 g of an OH-terminated polybutadiene, 190 g of a phthalate plasticizer and 50 g of a high-boiling hydrocarbon were homogeneously mixed in vacuo in a planetary mixer with 430 g precipitated chalk, 15 g silica and 47 g calcium oxide. 2 g of a commercially available tin catalyst (DBTL) and 4 g of a trifunctional polyether amine (molecular weight 440) were then added. Lastly, 40 g of a fine-particle dimerized toluene diisocyanate were stirred in in vacuo. A paste-like adhesive with a cure temperature of ca. 80° C. was obtained.

### Example 2

### Curing of a Bonded Joint in a Headlamp by NIR® Radiation

The adhesive of Example 1 was introduced into the groove of the glass or plastic headlamp lens, as shown in FIG. 1. The housing—optionally pretreated by a suitable method, for example plasma, primer or flame application—was then fitted together with the groove in accordance with the required geometry. The joint was then exposed to NIR® radiation from a commercially available, low-burn or normal-burn emitter (Adphos). It was important in accordance with the invention that the near IR radiation was introduced from the transparent side because only in this way could overheating of the non-transparent substrate be avoided. The adhesive was fully cured after ca. 10-100 seconds, depending on the radiation level, and satisfied the requirements for headlamp bonding.

1. A process for joining a first part to a second part, said process comprising forming a bonded joint between the first part and the second part using a heat-curable adhesive, at least one part being transparent to electromagnetic radiation in the region of the bonded joint, exposing the bonded joint to electromagnetic radiation and heating and curing the heat-curable adhesive, wherein at least significant parts of the electromagnetic radiation are in the wavelength range of the near infrared.

2. A process as claimed in claim 1, wherein the wavelength range of the electromagnetic radiation is between 0.7 μm and 1.5 μm.

3. A process as claimed in claim 1, wherein the at least one part in the region of the bonded joint is a material selected from the group consisting of glass, polymethylmethacrylate, polycarbonate and polystyrene.

4. A process as claimed in claim 1, wherein the heat-curable adhesive is based on a non-aqueous dispersion comprising at least one polyisocyanate deactivated only at the surface and at least one isocyanate-reactive polymer.

5. A process as claimed in claim 1, wherein the first part is a transparent part having a U-shaped grooved projection with a horizontal section situated on the side remote from the second part, the second part being non-transparent and having a tongue-like projection, wherein the bonded joint is a tongue-and-groove joint, and wherein the heat-curable adhesive fills the tongue-and-groove joint.

6. A process as claimed in claim 1, wherein at least one of the first part or the second part is a component of a vehicle headlamp or lamp housing.

7. A process as claimed in claim 1, wherein the electromagnetic radiation is obtained from a thermal emitter operated at an emission temperature of at least 2,900 K.

8. A process as claimed in claim 1, wherein the electromagnetic radiation is obtained from a halogen lamp.

9. A process as claimed in claim 1, wherein during the exposure of the bonded joint to electromagnetic radiation a control unit is used to control the energy input and the temperature of the heat-curable adhesive is controlled via at least one sensor.

10. A process as claimed in claim 1, wherein the heat-curable adhesive is based on a non-aqueous dispersion comprising at least one polyisocyanate solid at room temperature, which is in fine-particle form and only deactivated at the surface, and at least one polyol selected from the group consisting of polyether polyols, polyester polyols, polyacrylate polyols, polyolefin polyols, polyether ester polyols, hydroxyl functional polybutadienes and polyether amines.

11. A process as claimed in claim 10, wherein the non-aqueous dispersion is additionally comprised of at least one component selected from the group consisting of fillers, catalysts and plasticizers.

12. A process as claimed in claim 1, wherein at least one surface of at least one of the first part and the second part is pretreated prior to forming the bonded joint by application of at least one of plasma, primer or flame.

13. A process as claimed in claim 1, wherein the bonded joint is exposed to the electromagnetic radiation only in the region of the bonded joint that is transparent to electromagnetic radiation.
